(19) United States
(12) Patent Application Publication
(10) Pub. No.: US 2012/0130560 A1
(43) Pub. Date: May 24, 2012

(54) TEMPERATURE CONTROL MODULE AND TEMPERATURE CONTROL APPARATUS HAVING THE SAME

(75) Inventor: YongGak SIN, Anyang-si (KR)

(73) Assignee: LSIS CO., LTD.

(21) Appl. No.: 13/298,249

(22) Filed: Nov. 16, 2011

(30) Foreign Application Priority Data
Nov. 19, 2010 (KR) 10-2010-0115476

(51) Int. Cl. G05D 23/19

(52) U.S. Cl. 700/300

(57) ABSTRACT

Provided are a temperature control module and a temperature control apparatus. The temperature control module includes an input unit connected to a temperature measurement object to measure a temperature, a control unit comparing a temperature measurement value measured through the input unit to a preset target value to perform a proportional integral derivative (PID) control using the target value, thereby calculating an adjustment value when the temperature measurement value and the target value are different from each other, and an output unit outputting the calculated adjustment value to the outside under the control of the control unit.

### CROSS-REFERENCE TO RELATED APPLICATIONS

The present application claims priority under 35 U.S.C. 119 and 35 U.S.C. 365 to Korean Patent Application No. 10-2010-0115476, filed on Nov. 19, 2010, which is hereby incorporated by reference in its entirety.

### BACKGROUND

The present disclosure relates to a temperature control module, and more particularly, to an integrated temperature control module having input, control, and output functions and a temperature control apparatus having the same.

Temperature control apparatuses are being used in various fields such as food packaging machines, various industrial furnaces, semiconductor manufacturing apparatuses, plastic molding machines, etc. In recent, as the needs of high function, miniaturization, and low costs increase, it is required to combine a temperature control apparatus with a programmable logic controller (PLC).

The PLC represents a universal controller in which existing functional devices such as a relay, timer, and counter within a control panel are substituted with semiconductor devices such as integrated circuits (ICs) and transistors to add a calculation function to a basic sequence control function, thereby controlling a program. Also, a proportional integral derivative (PID) control is being most universally used as a method for controlling a temperature using the PLC in recent years.

The PID control represents a control operation in which the present measured value of an object to be controlled is compared to a preset target value to adjust an output value, thereby matching the present value with the target value in case where the present measured value and the target value are different from each other. That is, the PID control may be a control method including a combination of a proportional control (P), an integral control (I), and a derivative control (D).

In the temperature control apparatus using the PLC according to the related art, an analog input module, a PID control module, and an analog output module are independently provided and operated. Thus, this structure may have a bad influence on PID control performance. Also, when a PLC CPU (central processing unit) is abnormal, it may be impossible to normally control the temperature.

### SUMMARY

Embodiments provide an integrated temperature control module which performs input, control, and output functions.

Embodiments also provide an integrated temperature control module which occupies one programmable logic controller (PLC) base slot.

Embodiments also provide a temperature control module in which a temperature drift effect is minimized to reduce a measurement error due to a temperature variation and stably measure a temperature.

The object of the present invention is not limited to the aforesaid, but other objects not described herein will be clearly understood by those skilled in the art from descriptions below.

In one embodiment, a temperature control module includes: an input unit connected to a temperature measurement object to measure a temperature; a control unit comparing a temperature measurement value measured through the input unit to a preset target value to perform a proportional integral derivative (PID) control using the target value, thereby calculating an adjustment value when the temperature measurement value and the target value are different from each other; and an output unit outputting the calculated adjustment value to the outside under the control of the control unit.

The input unit and the output unit may occupy the same one programmable logic controller (PLC) base slot. The input unit may be disposed on an upper or lower portion of the PLC base slot, and the output unit may be disposed on a lower or upper portion of the PLC base slot corresponding to a side opposite to that on which the input unit is disposed.

The input unit may include: a resistance temperature detector (RTD) connected to the temperature measurement object to output a voltage value using a resistance value variable according to the temperature of the temperature measurement object; a first constant current source connected to one end of the RTD to apply a constant current; a second constant current source connected to the other end of the RTD to apply a constant current; a reference resistance connected to a lead line to which one of constant currents of the first and second constant current sources is applied to generate a reference voltage; and an A/D converter converting an analog voltage value outputted from the RTD into a digital signal.

The input unit may further include a first insulation part disposed between the input unit and the control unit to insulate the input unit from the control unit.

The control unit may include: an interface receiving a parameter from the outside; a PID calculator performing the PID control using the temperature measurement value and the preset target value to calculate the adjustment value; and a controller generating a pulse width modulation (PWM) control signal using the adjustment value calculated by the PID calculator and the parameter to output the generated PWM control signal into the output unit.

The control unit may further include a memory storing the received parameter and the calculated adjustment value.

The output unit may include an output part outputting the adjustment value calculated through the control unit to the outside.

The output part may be constituted by a transistor outputting the adjustment value to the outside according to a PWM control signal outputted through the control unit.

The output unit may further include a second insulation part disposed between the output unit and the control unit to insulate the output unit from the control unit.

In another embodiment, a temperature control apparatus includes: a constant temperature device corresponding to a temperature measurement object; and a temperature control module measuring a temperature of the constant temperature device to output an adjustment value for matching the measured temperature measurement value with a preset target value, wherein the temperature control module includes: an input unit measuring the temperature; a control unit calculating the adjustment value; and an output unit outputting the calculated adjustment value.

The input and output units constituting the temperature control module may occupy the same one PLC base slot.

The input unit constituting the temperature control module may include: a resistance temperature detector (RTD) connected to the temperature measurement object to output a voltage value using a resistance value variable according to the temperature of the temperature measurement object; a first constant current source connected to one end of the RTD to apply a constant current; a second constant current source connected to the other end of the RTD to apply a constant current; a reference resistance connected to a lead line to which one of constant currents of the first and second constant current sources is applied to generate a reference voltage; and an A/D converter converting an analog voltage value outputted from the RTD into a digital signal.

The control unit constituting the temperature control module may include: an interface receiving a parameter from the outside; a PID calculator performing the PID control using the temperature measurement value and the preset target value to calculate the adjustment value; and a controller generating a pulse width modulation (PWM) control signal using the adjustment value calculated by the PID calculator and the parameter to output the generated PWM control signal into the output unit.

The control unit may further include a memory storing the received parameter and the calculated adjustment value.

The output unit constituting the temperature control module may include an output part outputting the adjustment value to the outside according to a PWM control signal outputted through the control unit.

The output part may include a connection line for cooling output and a connection line for heating output to output the calculated adjustment value to the connection line for cooling output or the connection line according to the PWM control signal.

The details of one or more embodiments are set forth in the accompanying drawings and the description below. Other features will be apparent from the description and drawings, and from the claims.

### BRIEF DESCRIPTION OF THE DRAWINGS

FIG. 1 is a schematic block diagram of a temperature control module according to an embodiment.

FIG. 2 is a detailed circuit diagram of an input unit illustrated in FIG. 1.

FIG. 3 is a schematic block diagram of a control unit illustrated in FIG. 1.

FIG. 4 is a schematic block diagram of an output unit illustrated in FIG. 1.

FIG. 5 is a schematic view of a temperature control apparatus including the temperature control module illustrated in FIG. 1.

### DETAILED DESCRIPTION OF THE EMBODIMENTS

Terms or words used in the specification and claims should not be construed as limited to a lexical meaning, and should be understood as appropriate notions by the inventor based on that he/she is able to define terms to describe his/her invention in the best way to be seen by others.

Therefore, embodiments and drawings described herein are simply exemplary and not exhaustive, and it will be understood that various modifications and equivalents may be made to take the place of the embodiments.

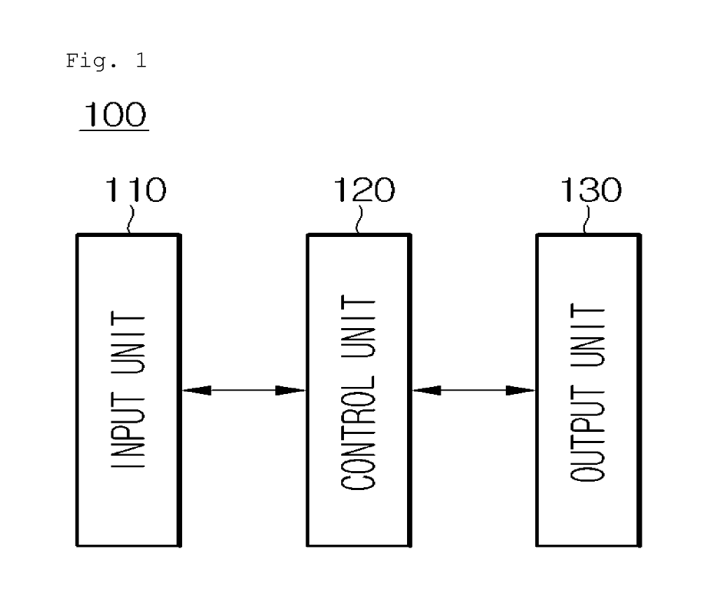

FIG. 1 is a schematic block diagram of a temperature control module according to an embodiment.

Referring to FIG. 1, a temperature control module 100 includes an input unit 110, a control unit 120, and an output unit 130.

The input unit 110 is connected to an object to be measured (hereinafter, referred to as a measurement object) to measure a temperature value corresponding to the measurement object. Specifically, the input unit 110 is connected to the measurement object to output a voltage corresponding to a current passing through the measurement object. The outputted voltage has a value corresponding to a temperature of the measurement object.

The control unit 120 receives the temperature measurement value of the measurement object outputted through the input unit 110 to output an adjustment value for adjusting the temperature of the measurement object on the basis of the received temperature measurement value.

Specifically, the control unit 120 compares the temperature measurement value to a target value. Then, when the temperature measurement value and the target value are different from each other, the control unit 120 calculates the adjustment value to match the temperature measurement value with the target value.

The output unit 130 receives the adjustment value calculated through the control unit 120 to transmit the received adjustment value into the measurement object. Thus, the output unit 130 allows the measurement object to be maintained at a constant temperature.

Here, the units are insulated from each other through insulators therebetween.

That is, an insulator having an insulation function is disposed between the input unit 110 and the control unit 120. Thus, operation reliability between the input unit 110 and the control unit 120 may be secured. Similarly, an insulation having an insulation function is disposed between the control unit 120 and the output unit 130 to secure operation reliability therebetween.

As described above, the temperature control module 100 according to the current embodiment includes the input unit 110, the control unit 120, and the output unit 130 which are integrated with each other.

Here, the input unit 110 and the output unit 130 for respectively performing the input and output functions of the temperature control module 100 are connected to a programmable logic controller (PLC) base slot. That is, the temperature control module 100 includes an input terminal block for inputting and an output terminal block for outputting. The input unit 110 and the output unit 130 are connected to the input terminal block and the output terminal block, respectively.

Here, the temperature control module 100 may be manufactured so that the input unit 110 for performing the input function and the output unit 130 for performing the output function occupy one PLC base slot.

That is to say, the input terminal block for inputting and the output terminal block for outputting constitute one common terminal block to perform the input and output functions using the one terminal block.

Thus, in the current embodiment, the temperature control module 100 may perform all of the input, control, and output functions. Also, the temperature control module 100 may perform the input and output functions through one PLC slot to reduce the number of occupied PLC base slot.

Hereinafter, the units will be described in detail with reference to the accompanying drawings.

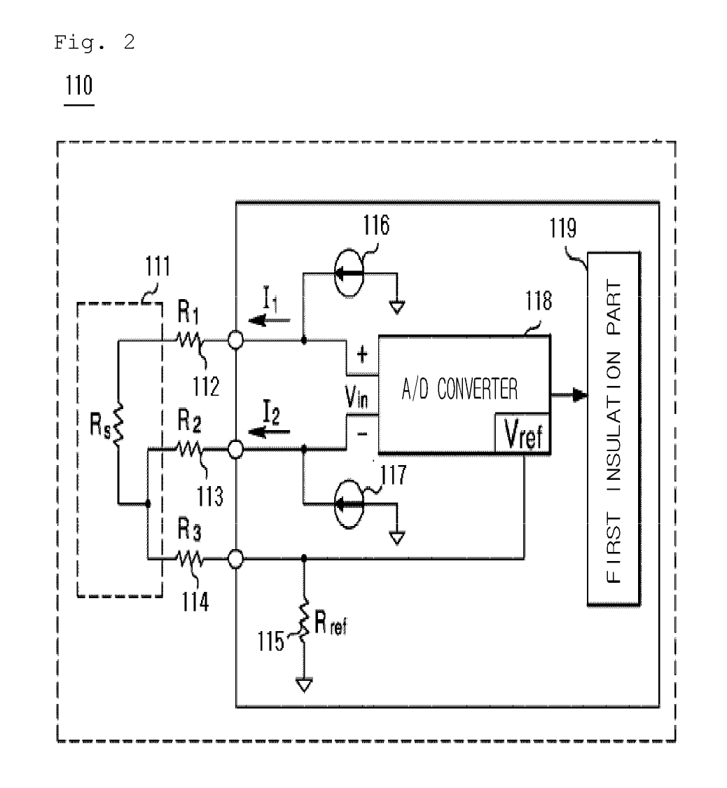

FIG. 2 is a detailed circuit diagram of an input unit illustrated in FIG. 1.

Referring to FIG. 2, the input unit 110 includes a measurement part 111, a first lead line 112, a second lead line 113, a third lead line 114, a reference resistance 115, a first constant current source 116, a second constant current source 117, an A/D converter 118, and a first insulation part 119.

The input unit 110 converts an analog temperature signal corresponding to the temperature of the measurement object into a digital temperature signal to output the converted temperature signal.

The measurement part 111 is connected to the measurement object to output a voltage corresponding to a current passing through the measurement object. The measurement part 111 may be realized using a resistance temperature detector (RTD).

The RTD may be a sensor for measuring a temperature using a method in which a resistance is directly varied according to a temperature coefficient. Thus, the RTD may convert the temperature of the measurement object into a resistance value corresponding to the temperature of the measurement object.

A 2-line or 3-line type RTD is representatively used as the RTD. The 2-line type RTD is driven by a current source. Here, since a current generated in the 2-line type RTD is constant, a voltage variation is proportional to a resistance variation due to a temperature.

Also, the 3-line type RTD is connected to a 3-line bridge circuit. An output voltage of the bridge circuit is used for detecting a resistance variation of the RTD. In the current embodiment, the 3-line type RTD is used to constitute the measurement part 111.

The measurement part 110 measures a temperature of the measurement object by outputting a voltage value using a resistance value Rs varied according to the temperature of the measurement object.

A first current I1 corresponding to the first constant current source 116 passes through the first lead line 112 of the above-described 3-line type RTD.

Also, a second current I2 corresponding to the second constant current source 117 passes through the second lead line 113 of the RTD.

Also, a third current in which the first current I1 flowing into the first lead line 112 and the second current I2 flowing into the second lead line 113 are mixed flows into the third lead line 114. Thus, the third current I1+I2 corresponding to twice as large as the first or second current I1 or I2 flowing the first or second lead line 122 or 124 passes through the third lead line 114.

As described above, since the third current I1+I2 corresponding to twice as large as the first or second lead line 112 or 113, a voltage applied to the third lead line 114 is twice. However, since the voltage is a common-mode voltage, an error due to the common-mode voltage does not occur.

The first and second constant current sources 116 and 117 are connected to the first and second lead lines 112 and 114 of the measurement part 111 in a state where the first constant current source 116 is matched with the second constant current source 117.

The first and second constant current sources 116 and 117 output the same current.

The current of the first constant current source causes a voltage error at a signal input end of the A/D converter 118 while passing through the first lead line 112. Thus, to compensate the voltage error, the second constant current source 117 connected to a (−) lead line of the A/D converter 118 is used.

The current of the second constant current source 117 passes through the second lead line 113. Here, the first and second lead lines 112 and 113 have the same material and length. Thus, the first and second lead lines 112 and 113 have the same resistance value.

Thus, when it is assumed that the first and second constant current sources 116 and 117 have the same current value, the voltage error occurring while passing through the first lead line 112 may be equal to that occurring while passing through the second lead line 113. Thus, the voltage errors may be offset each other and removed.

The input unit 110 includes a reference resistance 115 generating a reference voltage.

The reference resistance 115 is connected to the third lead line 114. The reference voltage generated in the reference resistance 115 is applied to a reference voltage input terminal (not shown) of the A/D converter 118. The reference voltage inputted into the A/D converter 118 determines a range of an input signal acceptable into the A/D converter 118.

When the currents outputted from the first and second constant current sources 116 and 117 are changed in intensity due to an effect of a temperature drift, error voltages occurring in the first and second lead lines 112 and 113 are offset each other.

Considering the voltage value outputted from the measurement part 111 except for the temperature drift effect depending on a component of the reference resistance 115, the voltage of the measurement part 111 may be changed in intensity (voltage applied to Rs) according to a current variation of the two constant current sources 116 and 117. Thus, the current variation has an influence on the voltage component applied to the measurement part 111 as well as the reference resistance 115 connected to the reference voltage input terminal of the A/D converter 118.

That is, when the currents of the first and second constant current sources 116 and 117 increase in intensity, the voltage applied to the reference voltage 115 increases to expand the range of the input signal acceptable into the A/D converter 118. Also, on the other hand, when the currents of the first and second constant current sources 116 and 117 decrease in intensity, the voltage applied to the reference voltage (Rref) 115 decreases to reduce the range of the input signal acceptable into the A/D converter 118.

Thus, when the temperature drift occurs, the temperature drift has an influence on the currents outputted from the first and second constant current sources 116 and 117, the voltage value (i.e., a resistance value of the RTD) of the measurement part 111, and the reference resistance (Rref) 115. Thus, the errors may be offset each other and the range of the input signal may not be affected by the current variation to get out of the temperature drift effect.

The A/D converter 118 is an analog-digital converter. Thus, the A/D converter 118 converts a voltage signal into a digital voltage signal.

The first insulation part 119 is constituted by an optocoupler. Also, the first insulation part 119 insulates the input unit 110 from the control unit 120.

That is, the first insulation part 119 may improve reliability of the temperature control module 100. The first insulation part 119 blocks a noise, a surge current, and a surge voltage between the input unit 110 and the control unit 120.

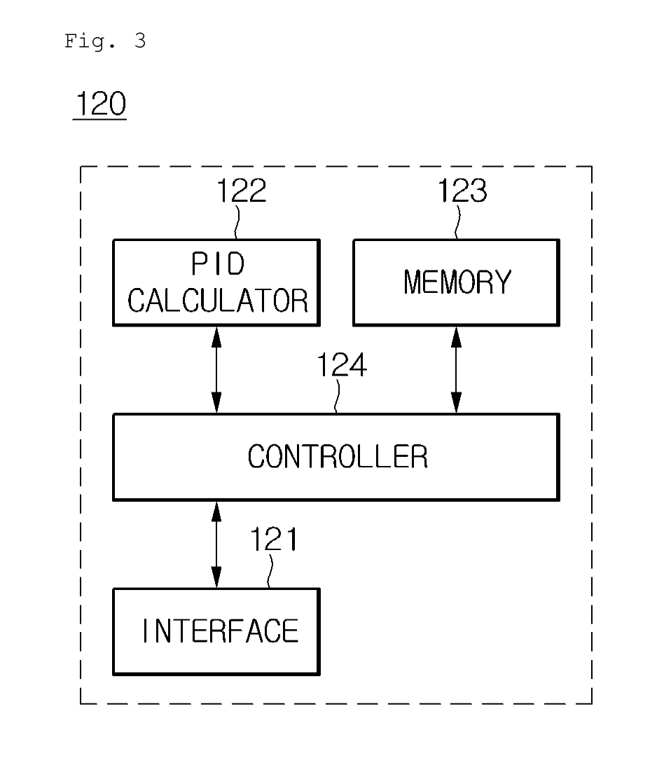

FIG. 3 is a schematic block diagram of the control unit 120 illustrated in FIG. 1.

Referring to FIG. 3, the control unit 120 includes an interface 121, a PID calculator 122, a memory 123, and a controller 124.

The control unit 120 compares a temperature measurement value outputted through the input unit 110 to a preset target value to perform a proportional integral derivative (PID) control.

The interface 121 communicates with the PLC CPU (not shown) through data. Specifically, the interface 121 receives preset parameters from the PLC CPU.

The preset parameters include an input parameter, a control parameter, and an output parameter.

The input parameter includes information with respect to an input sensor type of the temperature measurement object. Also, the control parameter includes information such as a PID setting coefficient required from performing the PID control. Also, the output parameter includes information with respect to an output type such as a heating output or a cooling output and information with respect to an output type such as an analog output or an on/off output.

The PID calculator 122 compares a temperature measurement value outputted through the input unit 110, i.e., a temperature measurement value PV converted by the A/D converter 118 to a preset target value SV. As a result, when the temperature measurement value PV and the target value SV are different from each other, the PID calculator 122 calculates an adjustment value MV to match the temperature measurement value PV with the target value SV.

The memory 123 stores the parameters received through the interface 121. Also, the memory 123 stores the adjustment value MV calculated through the PID calculator 122.

The controller 124 compares the temperature measurement value PV to the target value SV to control the PID calculator 122, thereby performing PID calculation. Then, the controller 124 stores the adjustment value MV calculated by the PID calculator 122 into the memory 123.

Also, controller 124 generates a pulse width modulation (PWM) control signal corresponding to the adjustment value MV calculated by the PID calculator 122 to transmit the PWM control signal into the output unit 130.

Here, the PWM control signal includes information with respect to the output type and information with respect to an output form.

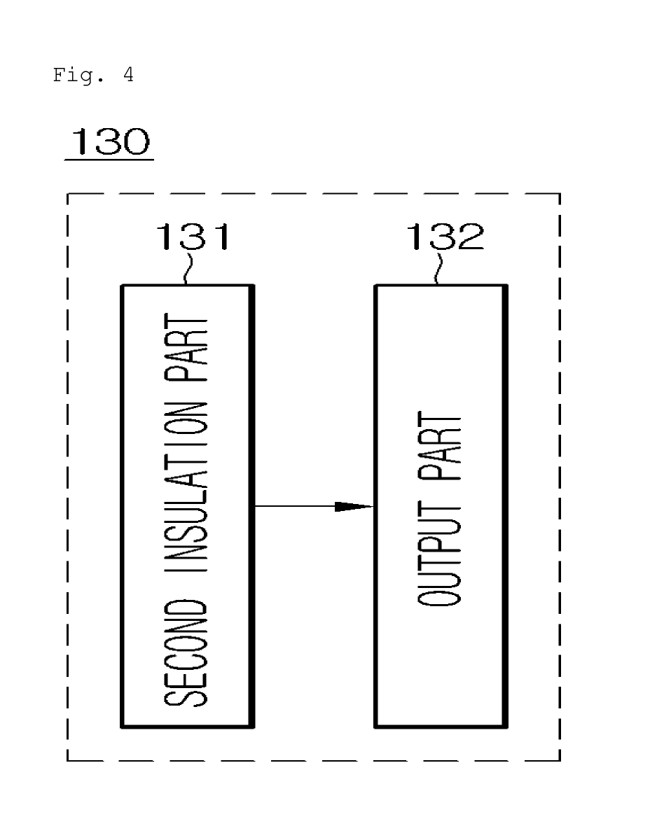

FIG. 4 is a schematic block diagram of the output unit 130 illustrated in FIG. 1.

Referring to FIG. 4, the output unit 130 includes a second insulation part 131 and an output part 132.

The output unit 130 receives the adjustment value calculated through the control unit 120 to output the received adjustment value to the outside.

Like the first insulation part 119, the second insulation part 131 is constituted by an optocoupler. Also, the second insulation part 131 insulates the control unit 120 from the output unit 130 to secure operation reliability.

The output part 132 outputs the adjustment value MV of the PID calculator 122 to the outside according to the PWM control signal transmitted from the control unit 120.

The output part 132 may be constituted by a transistor to output the information with respect to the output form included in the PWM control signal in an on/off output form.

As described above, the temperature control module according to the current embodiment may provide the integrated temperature control module which measures a temperature using the RTD and the transistor to reduce manufacturing costs and improve efficiency.

Also, the temperature drift effect may be minimized to reduce a measurement error due to a temperature variation and stably measure a temperature

Also, the input module and the output module may be manufactured to occupy one PLC base slot, thereby reducing manufacturing costs due to the purchase of an individual module and a volume of the temperature control module.

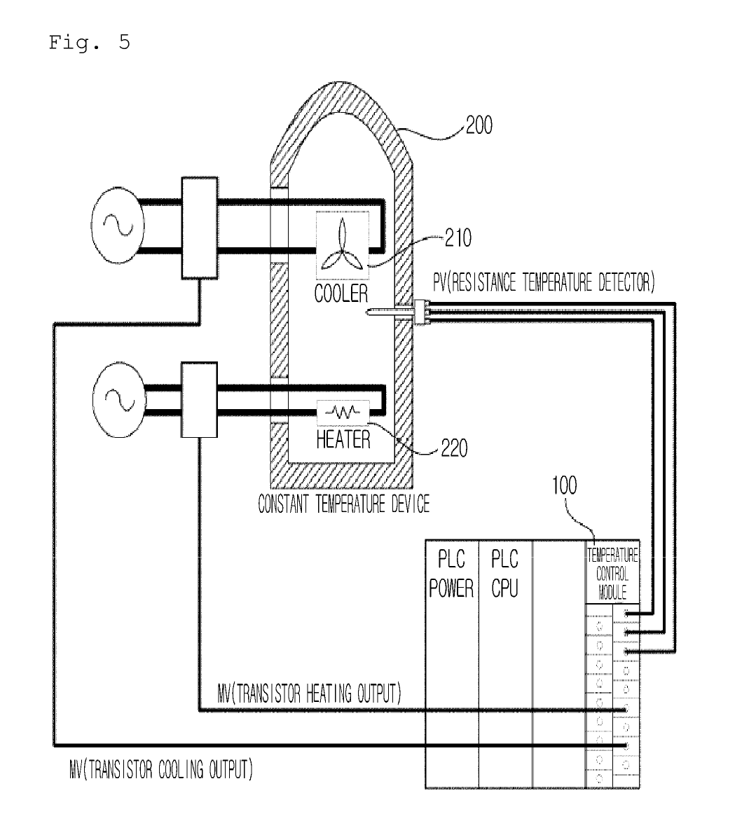

FIG. 5 is a schematic view of a temperature control apparatus including the temperature control module illustrated in FIG. 1.

Referring to FIG. 5, the temperature control module 100 receives a temperature value measured in the temperature measurement object 200 to convert the received temperature value into a digital value. That is, the temperature control module 100 compares the measurement value to the target value to calculate an adjustment value. Then, the temperature control module 100 generates an output corresponding to the calculated adjustment value.

Here, the temperature measurement object 200 includes a heater 210 and a cooler 220. Thus, the heater 210 and the cooler 220 are operated under the control of the temperature control apparatus to maintain a constant temperature.

The RTD for measuring a temperature of the temperature measurement object 200 is connected to an input part of the temperature control module 100. A transistor heating output for operating the heater 220 and a transistor cooling output for operating the cooler 220 are connected to an output part of the temperature control module 200.

Here, in the temperature control module 100, the input unit 110 for inputting and the output unit 130 for outputting occupy one PLC base slot. That is, one terminal block for inputting and outputting may be provided. Thus, the input (or output) may be performed at an upper portion of the terminal block, and the output (or input) may be performed at a lower portion of the terminal block. Therefore, the number of PLC base slot may be reduced into one.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A temperature control module comprising:
an input unit connected to a temperature measurement object to measure a temperature;
a control unit comparing a temperature measurement value measured through the input unit to a preset target value to perform a proportional integral derivative (PID) control using the target value, thereby calculating an adjustment value when the temperature measurement value and the target value are different from each other; and
an output unit outputting the calculated adjustment value to the outside under the control of the control unit.

2. The temperature control module according to claim 1, wherein the input unit and the output unit occupy the same one programmable logic controller (PLC) base slot.

3. The temperature control module according to claim 2, wherein the input unit is disposed on an upper or lower portion of the PLC base slot, and
the output unit is disposed on a lower or upper portion of the PLC base slot corresponding to a side opposite to that on which the input unit is disposed.

4. The temperature control module according to claim 1, wherein the input unit comprises:
a resistance temperature detector (RTD) connected to the temperature measurement object to output a voltage value using a resistance value variable according to the temperature of the temperature measurement object;
a first constant current source connected to one end of the RTD to apply a constant current;
a second constant current source connected to the other end of the RTD to apply a constant current;
a reference resistance connected to a lead line to which one of constant currents of the first and second constant current sources is applied to generate a reference voltage; and
an A/D converter converting an analog voltage value outputted from the RTD into a digital signal.

5. The temperature control module according to claim 4, wherein the input unit further comprises a first insulation part disposed between the input unit and the control unit to insulate the input unit from the control unit.

6. The temperature control module according to claim 1, wherein the control unit comprises:
an interface receiving a parameter from the outside;
a PID calculator performing the PID control using the temperature measurement value and the preset target value to calculate the adjustment value; and
a controller generating a pulse width modulation (PWM) control signal using the adjustment value calculated by the PID calculator and the parameter to output the generated PWM control signal into the output unit.

7. The temperature control module according to claim 6, wherein the control unit further comprises a memory storing the received parameter and the calculated adjustment value.

8. The temperature control module according to claim 1, wherein the output unit comprises an output part outputting the adjustment value calculated through the control unit to the outside.

9. The temperature control module according to claim 8, wherein the output part is constituted by a transistor outputting the adjustment value to the outside according to a PWM control signal outputted through the control unit.

10. The temperature control module according to claim 8, wherein the output unit further comprises a second insulation part disposed between the output unit and the control unit to insulate the output unit from the control unit.

11. A temperature control apparatus comprising:
a constant temperature device corresponding to a temperature measurement object; and
a temperature control module measuring a temperature of the constant temperature device to output an adjustment value for matching the measured temperature measurement value with a preset target value,
wherein the temperature control module comprises:
an input unit measuring the temperature;
a control unit calculating the adjustment value; and
an output unit outputting the calculated adjustment value.

12. The temperature control apparatus according to claim 11, wherein the input and output units constituting the temperature control module occupy the same one PLC base slot.

13. The temperature control apparatus according to claim 11, wherein the input unit constituting the temperature control module comprises:
a resistance temperature detector (RTD) connected to the temperature measurement object to output a voltage value using a resistance value variable according to the temperature of the temperature measurement object;
a first constant current source connected to one end of the RTD to apply a constant current;
a second constant current source connected to the other end of the RTD to apply a constant current;
a reference resistance connected to a lead line to which one of constant currents of the first and second constant current sources is applied to generate a reference voltage; and
an A/D converter converting an analog voltage value outputted from the RTD into a digital signal.

14. The temperature control apparatus according to claim 11, wherein the control unit constituting the temperature control module comprises:
an interface receiving a parameter from the outside;
a PID calculator performing the PID control using the temperature measurement value and the preset target value to calculate the adjustment value; and
a controller generating a pulse width modulation (PWM) control signal using the adjustment value calculated by the PID calculator and the parameter to output the generated PWM control signal into the output unit.

15. The temperature control apparatus according to claim 11, wherein the control unit further comprises a memory storing the received parameter and the calculated adjustment value.

16. The temperature control apparatus according to claim 11, wherein the output unit constituting the temperature control module comprises an output part outputting the adjustment value to the outside according to a PWM control signal outputted through the control unit.

17. The temperature control apparatus according to claim 16, wherein the output part comprises a connection line for cooling output and a connection line for heating output to output the calculated adjustment value to the connection line for cooling output or the connection line according to the PWM control signal.
